(19) United States
(12) Patent Application Publication
(10) Pub. No.: US 2009/0024489 A1
(43) Pub. Date: Jan. 22, 2009

(54) REPUTATION BASED DISPLAY

(75) Inventors: Ashish Ramgopal Baldua, San Jose, CA (US); Vineet Kumar Gossain, Mountain View, CA (US); Kevin Patrick Rogan, Los Gatos, CA (US)

Correspondence Address: BEYER LAW GROUP LLP/YAHOO, PO BOX 1687, CUPERTINO, CA, 95015-1687, US

(73) Assignee: YAHOO! INC., Sunnyvale, CA (US)

(21) Appl. No.: 11/778,600

(22) Filed: Jul. 16, 2007

(51) Int. Cl. G06Q 30/00

(52) U.S. Cl. 705/27

(57) ABSTRACT

A computer-implemented method for managing the display of items to which consumers may respond, which comprises the following: determining a first display position for an item based at least in part on a reputation associated with a profile to which the item belongs; causing the item to be displayed at the first display position; and during a lifetime of the item, adjusting the reputation associated with the profile to which the item belongs based on an aggregated consumer response with respect to the item, adjusting the display position of the item to a second display position based at least in part on the adjusted reputation associated with the profile, and causing the item to be displayed at the second display position.

### BACKGROUND OF THE INVENTION

1. Field of the Invention

The present invention relates to systems and methods for managing the display of items on pages such as web pages of a website. More specifically, the present invention relates to systems and methods for determining appropriate or suitable positions on the web pages for displaying the items and adjusting display positions for the items based on one or more performance characteristics associated with the items.

2. Background of the Invention

There is a great amount of information available on the Internet. Often, when a person searches for a particular subject matter or piece of information, he or she may find hundreds, even thousands of choices. For example, assuming a person is looking for information related to French cuisine, by searching for the term “French cuisine” using a web search engine, such as the Yahoo!® search engine, the person may receive over ten million hits (i.e., links). It is impractical, even impossible for the person to click and read through all the links; instead, it is more likely that the person only reads several links near the top of the list. Similarly, when a consumer is looking for a bracelet online, he or she may search for the bracelet at one or more online shopping sites, such as Yahoo!® Shopping. Again, by searching for the term “bracelet” at an online shopping site, the consumer may be offered many choices. Or, when a person is looking for vacation packages, he or she may look at online travel sites, such as Yahoo!® Travel, for possible deals, and yet, there may be a large number of vacation packages to different destinations on different dates for different prices being offered and shown on the web pages at any given time. The person may have to read through descriptions about many packages in order to locate the one package that fits the person's requirements.

It is not unusual for a website to offer thousands or tens of thousands of merchandise or services at any given time. Similarly, a website may display a great number of listings of various natures, often spread over many web pages. Therefore, a choice needs to be made with respect to how these items, listings, and/or offers are to be displayed on the web pages. Again, it is impractical for people, such as consumers, viewers, or users, to read through all the available items, listings, and/or offers, and it is more likely that those items, listings, and/or offers displayed at certain positions, such as near the top of the list, are viewed by the viewers or consumers more often than those items, listings, and/or offers displayed near the bottom of the list.

Among the tens of thousands of items, listings, and/or offers, some may be more interesting or attractive to the viewers or consumers than others, perhaps due to their prices or various other factors. For example, some merchandise offers may include special deals, discounts, free shipping, extended warranty, etc. And yet, these interesting or attractive listings and/or offers may be rarely noticed by the viewers or consumers if they are displayed at less prominent or noticeable positions on the web pages, such as near the bottom of the pages or on subsequent pages. As a result, viewers or consumers may spend much time searching for listings and/or deals and not finding what they desire, while the more interesting or desirable listings and/or offers are lost among the great number of available listings and/or offers.

Accordingly, what are needed are systems and methods to address the above-identified problems.

### SUMMARY OF THE INVENTION

Broadly speaking, the present invention relates to systems and methods for managing the display of items on pages.

In one embodiment, a computer-implemented method for managing the display of items to which consumers may respond is provided, which comprises the following: determining a first display position for an item based at least in part on a reputation associated with a profile to which the item belongs; causing the item to be displayed at the first display position; and during a lifetime of the item, adjusting the reputation associated with the profile to which the item belongs based on an aggregated consumer response with respect to the item, adjusting the display position of the item to a second display position based at least in part on the adjusted reputation associated with the profile, and causing the item to be displayed at the second display position.

In another embodiment, a computer-implemented method for adjusting a reputation associated with a moderator who recommends items to consumers is provided, which comprises the following: receiving a selection from the moderator with respect to an item displayed at a first display position; adjusting the display position of the item to a second display position based at least in part on the reputation associated with the moderator; causing the item to be displayed at the second display position; monitoring performance of the item; receiving an indication that the selection with respect to the item is completed; and adjusting the reputation associated with the moderator based at least in part on the performance of the item.

In another embodiment, a computer program product for managing the display of items to which consumers may respond comprising a computer-readable medium having a plurality of computer program instructions stored therein is provided. The plurality of computer program instructions are operable to cause at least one computing device to: determine a first display position for an item based at least in part on a reputation associated with a profile to which the item belongs; cause the item to be displayed at the first display position; and during a lifetime of the item, adjust the reputation associated with the profile to which the item belongs based on an aggregated consumer response with respect to the item, adjust the display position of the item to a second display position based at least in part on the adjusted reputation associated with the profile, and cause the item to be displayed at the second display position.

In another embodiment, a computer program product for adjusting a reputation associated with a moderator who recommends items to consumers comprising a computer-readable medium having a plurality of computer program instructions stored therein is provided. The plurality of computer program instructions are operable to cause at least one computing device to: receive a selection from the moderator with respect to an item displayed at a first display position; adjust the display position of the item to a second display position based at least in part on the reputation associated with the moderator; cause the item to be displayed at the second display position; monitor performance of the item; receive an indication that the selection with respect to the item is completed; and adjust the reputation associated with the moderator based at least in part on the performance of the item.

These and other features, aspects, and advantages of the invention will be described in more detail below in the detailed description and in conjunction with the following figures.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is an illustration of a web page having multiple display positions for displaying various items.

FIG. 2 is a flowchart of a method that determines and adjusts the display position of an item on a web page.

FIG. 3 is a sample illustration of the steps resulting in an item to be moved into a more prominent display position.

FIG. 4 is a flowchart of a method that adjusts a moderator's reputation.

FIG. 5 is a simplified diagram of a network environment in which specific embodiments of the present invention may be implemented.

### DETAILED DESCRIPTION OF THE INVENTION

The present invention will now be described in detail with reference to a few preferred embodiments thereof as illustrated in the accompanying drawings. In the following description, numerous specific details are set forth in order to provide a thorough understanding of the present invention. It will be apparent, however, to one skilled in the art, that the present invention may be practiced without some or all of these specific details. In other instances, well known process steps and/or structures have not been described in detail in order to not unnecessarily obscure the present invention. In addition, while the invention will be described in conjunction with the particular embodiments, it will be understood that it is not intended to limit the invention to the described embodiments. To the contrary, it is intended to cover alternatives, modifications, and equivalents as may be included within the spirit and scope of the invention as defined by the appended claims.

A website that offers merchandise, services, and/or displays other items or listings usually arranges and displays the great number of available items or listings based on various criteria so that it is easier for consumers to locate the specific items or listings they desire. Items or listings may be divided into categories and sub-categories, and related items or listings may be grouped together and displayed on separate web pages. A group of related items or listings may be displayed on a web page in order of price, popularity, brand name, etc. For example, with an online shopping website, such as Yahoo!® Shopping, at the top level, merchandise may be divided into categories such as “Clothing & Accessories,” “Computers,” “Electronics,” etc. And within each profile merchandise may be further divided into sub-categories. For example, within the “Electronics” category, merchandise may be further divided into “iPods,” “Cameras,” “TVs,” “Phones,” etc. Depending on what a consumer is looking for, he or she may go to the appropriate categories and/or sub-categories by clicking on the corresponding links shown on the web pages. Similarly, with an online travel website, such as Yahoo!® Travel, at the top level, a person may select from categories such as “Flights,” “Hotels”, “Cars”, “Cruises,” etc. In addition, the website may display current special deals offered by various travel service providers, such as airlines or hotels. A separate web page or group of web pages may be devoted to these special deals so that they are easily found by the consumers.

In addition, items or listings may be grouped together based on customized criteria specified by the consumers or viewers. For example, a person may search for information related to a specific topic using a web search engine, or a consumer may search for a particular type of merchandise at an online shopping site. The results of the searches (i.e., listings or offers) may optionally be organized into groups and displayed on one or more web pages according to some type of order.

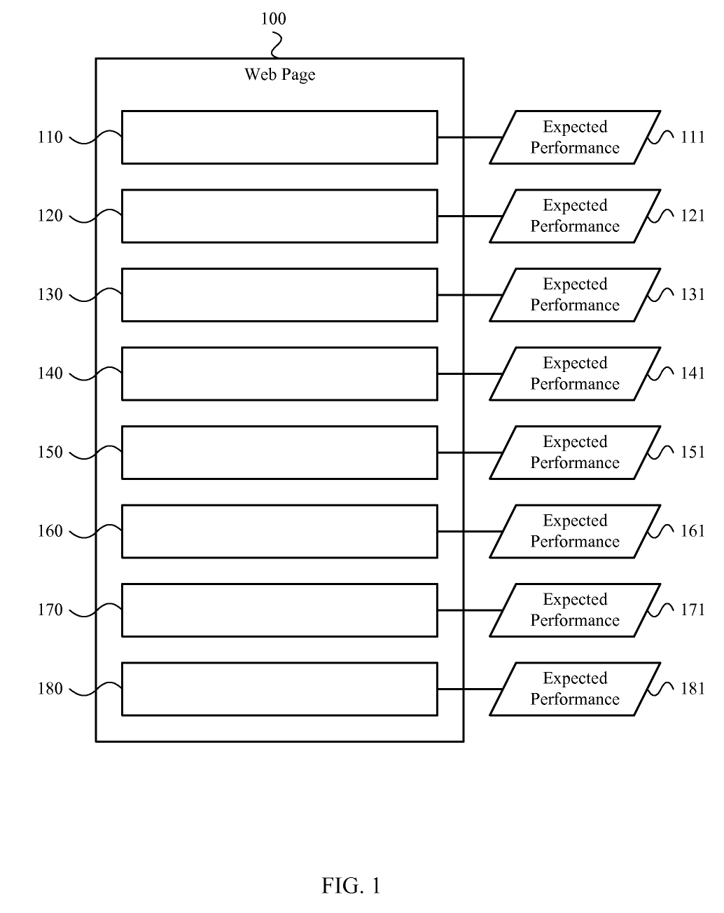

On a particular web page, items or listings (e.g., merchandise and/or services) are often displayed in sequence, such as, for example, from top to bottom or from left to right. FIG. 1 is an illustration of a web page 100 with eight display positions 110, 120, 130, 140, 150, 160, 170, 180 arranged from the top to the bottom of the page 100. Each display position 110, 120, 130, 140, 150, 160, 170, 180 may be used to display an item or a listing, such as a piece of merchandise offered for sale. In the case of a web page devoted to special deals from a travel website, for example, each of the eight positions 110, 120, 130, 140, 150, 160, 170, 180 may be used to display a discount vacation package, a special weekend deal offered by a particular hotel, a last-minute cruise package, etc.

When a person views such a web page 100 with multiple items or listings displayed thereon, it is more likely for the person to notice those items displayed near the top of the page (e.g., items displayed at positions 110 and 120) than those items displayed near the bottom of the page (e.g., items displayed at positions 170 and 180) because of the prominence of their display positions near the top of the page, especially when a large number of items are displayed on a single web page. Consequently, items or listings displayed near the top of the page (e.g., items displayed at positions 110 and 120) are more likely to be acted on or engaged by the viewer (e.g., selected or purchased by a consumer). Therefore, display positions near the top of the page (e.g., positions 110 and 120) are more valuable than display positions near the bottom of the page (e.g., positions 170 and 180), because they provide more visibility to the viewers or consumers. Such prominent display positions are expected to result in better performance for items or listings displayed at those positions, such as selling the merchandise or services. Therefore, it is generally desirable to display more attractive or interesting items or listings at more prominent display positions.

Each display position 110, 120, 130, 140, 150, 160, 170, 180 on a web page 100 may be associated with an expected performance level 111, 121, 131, 141, 151, 161, 171, 181 that indicates how well an item displayed at that position is expected to perform. Performance of an item may be measured based on various factors, depending on the nature of the item and/or the particular requirements of the website. For example, if the item is a piece of merchandise offered for sale, then one factor that may be used to measure the performance of the item may be the sales per month of that item.

Numerical or other types of rating systems may be used to represent the values of the expected performance levels 111, 121, 131, 141, 151, 161, 171, 181 associated with the display positions 110, 120, 130, 140, 150, 160, 170, 180. For example, a range of numbers may be used to represent the values of the expected performance levels 111, 121, 131, 141, 151, 161, with higher numbers denoting higher expected performance levels and lower numbers denoting lower expected performance levels. Typically, positions near the top of the web page (e.g., positions 110 and 120) have higher expected performance values than positions near the bottom of the page (e.g., positions 170 and 180). In other words, the expected performance values 111, 121, 131, 141, 151, 161, 171, 181 would generally decrease as the prominence of the corresponding display positions 110, 120, 130, 140, 150, 160, 170, 180 decreases.

The expected performance values 111, 121, 131, 141, 151, 161, 171, 181 associated with the display positions may be determined based at least in part on aggregated historical data that indicate how well items displayed at the corresponding positions 110, 120, 130, 140, 150, 160, 170, 180 have performed in the past. For example, assuming that based on past experiences of a travel website that offers cruise packages on a particular web page, on average the consumers have interacted with (e.g., have viewed, purchased, recommended, etc.) 50% of the cruise packages displayed at position 110, have interacted with 25% of the cruise packages displayed at position 140, and have only interacted with 5% of the cruise packages displayed at position 180, the expected performance 111 associated with position 110 based on past sales is then 50%, the expected performance 141 associated with position 140 is 25%, and the expected performance 181 associated with position 180 is 5%.

The concept is not limited to a single web page shown in FIG. 1 only; instead, it may be extended to multiple web pages. For example, a group of related items or listings may be displayed across multiple web pages arranged in order. The viewers are shown the first web page first. In order to view the subsequent web pages, the viewers may need to perform some action, such as clicking on the “Next” button or link. In this case, the display positions on the first web page may be considered more prominent than the display positions on the second web page, which may be considered more prominent than the display positions on the third web page, and so on, since to view the next level of web page, the viewers may need to perform some action. In other words, with each additional level of web pages, the prominence of the display positions on the web pages decreases, and thus their expected performance levels decrease. Thus, within each web page, the expected performance levels of the display positions decrease as the prominence of the display positions decrease. Across multiple related web pages, the expected performance level of the most prominent display position on the second web page may still be less than the expected performance level of the least prominent display position on the first web page, the expected performance level of the most prominent display position on the third web page may still be less than the expected performance level of the least prominent display position on the second web page, and so on.

An expected performance level may be associated with each of the display positions on all the web pages from a website. For each web page, the expected performance values associated with the display positions on that web page may also be affected by the content, link path, traffic volume, or other characteristics of the web page itself. For example, at a particular website, a web page that is devoted to display sales items or special deals may be acted on or interacted with more often by consumers than a web page that is devoted to display generic items. Thus, the expected performance values associated with the display positions on a sales or special deals web page may be adjusted (e.g., increased) accordingly to reflect the fact that there is more consumer interactions (i.e., traffic volume) with respect to this one particular web page than other pages.

From time to time, the expected performance values for the different display positions may be updated or adjusted based on new data indicating how well items displayed at the corresponding positions have performed recently, so that the expected performance values may be accurately reflected in the performance of the corresponding display positions. For example, if items displayed at Position 150 on web page 100 have consistently outperformed the corresponding expected performance value 151 for the past two months, the expected performance value 151 may be increased to reflect this change. Conversely, if items displayed at Position 120 have consistently underperformed the corresponding expected performance value 121 for a period of time, the expected performance value 121 may be decreased accordingly.

As explained above, within a particular web page, display positions near the top of the web page (i.e., display positions with higher expected performance values) are usually more valuable than display positions near the bottom of the page (i.e., display positions with lower expected performance values). However, due to the limited number of prominent display positions available on each web page, not all items can be displayed at positions with relatively high expected performance values. Choices need to be made and some items must be pushed toward the bottom of the web pages. Therefore, in order for a website to have better overall performance, it is desirable to display more popular or attractive items at more prominent display positions (e.g., near the top of the web pages) so that they are easily found by the viewers. In other words, the relatively more prominent display positions should be used to display items or listings that may result in larger number of viewer interactions.

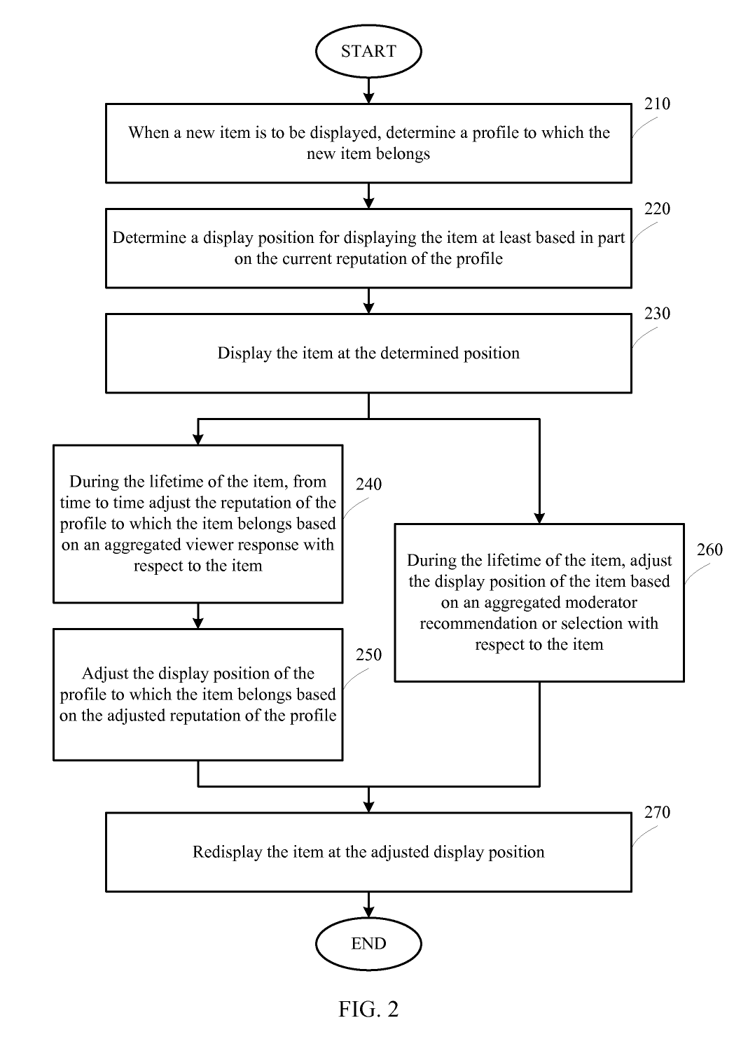

FIG. 2 is a flowchart of a method that determines and adjusts the display position of an item on a web page. As explained above, items or listings such as offers for merchandise or services are often organized into categories and sub-categories and similar items, such as items belonging to the same category or sub-category, are often grouped together to be displayed on separate web pages. Various criteria may be used to define a particular category and/or sub-category. Similarly, search results based on viewer specified search criteria may be organized and arranged to be displayed one or more web pages. Using again the travel website as an example, currently available hotel offers may be grouped into many categories based on names and locations of the hotels, dates of travel, room types, prices, etc., and a profile may be associated with each group of related or similar offers. For example, one group, named “Hotel-Las Vegas-5 Star,” may include all hotel offers that meet the following criteria: (1) having a five-star rating, (2) located in the city center of Las Vegas, (3) offering a room with two Queen-size beds or a King-size bed, and (4) requiring two-weekend-night stay in the month of May. The profile for “Hotel-Las Vegas-5 Star” may include these criteria.

A reputation may be associated with each profile, which indicates how well items described by or associated with that profile have performed. For example, the reputation values may be determined based at least in part on aggregated historical data that indicate how well items associated with the corresponding profile have performed in the past. In the context of a website selling merchandise, the performance value for an item may be based in part on how popular that item is among the consumers or how well that item has been sold to the consumers. Thus, a popular item or an item that has been sold in greater quantity may have a higher performance value. Consequently, a profile that describes or is associated with many popular items in turn has a relatively higher reputation value, and a profile that describes or is associated with items not well received by the consumers has a relatively lower reputation value. Numerical or other types of rating systems may be used to represent the reputation values. A relatively high reputation value may indicate that items described by or associated with the corresponding profile have historically performed well, and a relatively low reputation value may indicate that items described by or associated with the corresponding profile have historically performed poorly.

When appropriate, the reputation values associated with the profiles may be adjusted or updated to reflect how well items described by those profiles have performed more recently. The frequency of the adjustment may be decided by the system hosting the website. For example, the adjustment may be done on a regular basis. If items associated with a particular profile have gradually increased in popularity among the consumers (e.g., resulted in higher sales or received better consumer ratings or reviews), then the reputation value associated with that profile may be increased accordingly to reflect the changes. Conversely, if items associated with a profile have gradually decreased in popularity among the consumers, the reputation value associated with that profile may be decreased accordingly.

Because a relatively high reputation value indicates that items describe by or associated with the corresponding profile generally perform well and are popular among the consumers, items described by such a profile may be displayed at more prominent positions on a web page (i.e., display positions with higher expected performance values) so that it is easier for viewers or consumers to notice these popular items, which in turn may help further increase the performance of these popular items (e.g., boost the sales of the items). At the same time, the limited number of more prominent, and thus more valuable, display positions on the web pages are not wasted on displaying unpopular items that would not be well-received by the consumers.

In other words, a correlation may be made between the reputation value of a profile and the expected performance value of a display position. Generally speaking, a profile with a relatively high reputation value often describes items that are popular among the viewers or consumers. At the same time, a display position with a relatively high expected performance value is more prominent and thus more noticeable by the viewers or consumers. Therefore, in order to fully realize the potentials of these prominent display positions, display positions with higher expected performance values (i.e., prominent display positions) should be used to display items described by profiles with higher reputation values (i.e., items that often perform well).

A profile may be assigned to a display position based on the respective reputation value and expected performance value. Profiles with relatively higher reputation values are assigned to display positions with relatively higher expected performance values, and profiles with relatively lower reputation values are assigned to display positions with relatively lower expected performance values. Items described by or associated with a particular profile are displayed at the display position(s) assigned to that profile. Thus, on a particular web page, the most prominent display position (e.g., position 110 of FIG. 1) would be reserved for items described by or associated with a profile that has the highest reputation level, and so on.

The display position(s) assigned to each of the profiles may change from time to time. In other words, the correlation between a profile and its corresponding display position(s) is dynamic. The frequency of the change may vary depending on each particular implementation. Recall that the reputation values of profiles may change or be adjusted from time to time, based on how well items described by or associated with the respective profiles perform to reflect the performance changes with time. Thus, the display position(s) assigned to a profile may change as the reputation value associated with that profile changes. If the profile's reputation value increases, the profile may be assigned to a more prominent display position. If the profile's reputation level decreases, the profile may be assigned to a less prominent display position.

Generally speaking, if items associated with a particular profile have generally performed well in the past (i.e., the profile has a relatively high reputation value), then a new item described by the same profile may be expected to perform well too, because items described by the same profile share same or similar characteristics. For example, if a particular type of mobile telephone with a specific list of features have sold well in the past, a new mobile telephone, perhaps a different brand or model, with the same list of features may be expected to be well-received by the consumers too. The same is also true for profiles describing items that have generally performed poorly in the past (i.e., profiles having relatively low reputation values). Thus, a profile's reputation value may be used as an initial measurement to indicate how well a new item being added to that profile may perform. In this sense, a new item or listing “inherits” the reputation value of the profile with which it associates.

One reason for using a profile's reputation value as the initial indication of the performance of a new item or listing described by that profile is that for certain items, their lifespan may be relatively short, and so there may not be sufficient time to determine these items' actual performance based on viewer or consumer responses specifically with respect to these items. For example, a merchant may offer a particular item for sale at a great discount price, but only for a weekend, a day, or even a few hours. During the lifespan of the item, there may not be enough time and/or consumer responses to determine the appropriate display position for the item. It is also desirable to display the item at the appropriate display position from the very beginning when the deal is first offered so that the item may realize its full sales potential.

At 210, when a new item is to be displayed, the profile with which the item associates may be determined so that the reputation value associated with that profile may be used to determine an appropriate initial display position on a web page for the new item. An item is associated with a profile if the item meets all the criteria defined or described by that profile. Using the “Hotel-Las Vegas-5 Star” profile as an example, if a hotel offers a new deal that meets all four criteria described above for this particular profile, then the new hotel deal belongs to the “Hotel-Las Vegas-5 Star” profile. If any of the criteria is not met (e.g., the hotel is not rated 5 star or is not located in the city center of Las Vegas), then the new hotel deal does not belong to the “Hotel-Las Vegas-5 Star” profile.

If the new item does not match any of the existing profiles, then a new profile may be created based on some suitable criteria that distinctively describe the new item and profile, and a default reputation value may be initially assigned to the new profile. For example, the default reputation value may be the medium value or some other value among the range of possible reputation values associated with all the profiles. Thus, if the reputation values for all the profiles may range from 1 to 100, then the default reputation value would be 50 if the medium value is used as the default value, or could be 20 or some other number between 1 and 100 if some other criteria are used to select the default value. As data become available indicating how well the item performs, the reputation value associated with the profile may be adjusted accordingly.

Once the new item is matched with a profile, the new item inherits the current reputation value of the profile. At 220, the initial display position for the new item is determined based on the current reputation value of the profile to which the item belongs. As described above, all the profiles have reputation levels, and these reputation levels may be used to arrange the order of display for the profiles. Items associated with profiles of relatively higher reputation levels are displayed before (i.e., in more prominent display positions) items associated with profiles of relatively lower reputation levels. In other words, items may be displayed in the decreasing order of their corresponding profiles' reputation levels.

If multiple items from the same profile are available at the same time, a decision should be made as to the order of display among these multiple similar items. Multiple display positions may be assigned to the same profile in order to accommodate these items. The decision may be based on the specific requirements, needs, or preferences of the website, or may even be arbitrary. For example, items from the same profile may be displayed in the order of dates (e.g., newest to oldest or oldest to newest) or in the order of prices (e.g., highest to lowest prices or lowest to highest prices). Alternatively, items associated with the same profile may be displayed together in a group, and may be expanded in response to some type of viewer interaction. Then, the profiles may be displayed in the order of reputation values, and so on. The display positions of the existing items currently being displayed may need to be adjusted accordingly to accommodate the new item.

It is also possible, although perhaps unlikely, that more than one profile may temporarily have the same reputation value. In this case, a decision again should be made as to the order of display among these multiple profiles. The decision may be based on the specific requirements, needs, or preferences of the website, or may even be arbitrary. For example, a relatively newer item associated with one of the profiles may be displayed before a relatively older item associated with another one of the profiles having the same reputation value.

Once the appropriate display position for the new item has been determined, at 230, the item is displayed on the web page at the determined initial display position so that viewers or consumers may have access to it, such as viewing, purchasing, rating, etc.

A particular item may have a limited life span. For example, a piece of merchandise or a special deal may be available only for a specific period of time. Often, items sold at discount prices may be sold out soon. For certain types of items, their life spans may be relatively short, while other types of items may have relatively longer life spans.

During the lifetime of an item, while the item is being displayed on a web page, viewers may provide positive or negative actions or responses with respect to the item. At 240, the reputation value associated with the profile to which the item belongs may be adjusted from time to time based on an aggregated viewer or consumer action or response with respect to the item. The word “aggregated” as used here indicates that all viewer or consumer actions or responses with respect to the item are taken into consideration when the reputation value of the profile to which the item belongs is adjusted. Generally, positive viewer or consumer actions or responses may increase the reputation value of the profile, and negative viewer or consumer actions or responses may decreases the reputation value of the profile. By doing so, the reputation value associated with a profile is continuously adjusted to reflect the recent viewer or consumer responses with respect to the items described by or associated with that profile. In other words, the reputation associated with a profile reflects how well items in that profile perform among the viewers or consumers.

What is considered a positive or negative viewer or consumer action or response again may depend on the specific requirements, needs, or preferences of the particular website. For example, positive consumer actions or responses may include a mouse click on the link associated with the item, perhaps in order to view full description of or get further detailed information on the item, a positive review or rating given to the item, a “thumbs-up” on the item, a recommendation to another person with respect to the item, such as emailing the item to a friend, an actual purchase of the item, etc. Negative consumer actions or responses may include mere viewing of the item, perhaps with no further action taken, a negative review or rating given to the item, a “thumbs-down” on the item, etc.

Different weights may be given to different types of viewer or consumer actions or responses when adjusting the reputation values associated with the profiles based on these actions or responses. In other words, certain types of actions or responses may be given more weight and cause the profile reputation values to be adjusted more than other types. For example, when an item is actually purchased by a consumer, it may be a stronger indication that the item is popular among the consumers than when a consumer merely clicks on the link associated with the item to read additional descriptions of the item. Thus, a “purchase” action may be given more weight than a “click” action when the responses are used to adjust the reputation values associated with the profiles to which the items is associated with. In other words, a viewer action or response with a stronger or heavier weight may cause the reputation value to be adjusted (e.g., either increased or decreased) more than a viewer action or response with a weaker or lighter weight.

There are different ways to implement the weight factor for the consumer responses. For example, different numerical values representing different weight factors may be assigned to different types of viewer actions or responses. The numerical values may be multiplied with the corresponding types of viewer actions or responses when the profile reputation values are calculated. One possible formula for calculating the adjusted profile reputation may be

adjusted reputation=current reputation+Σ(positive_actionᵢ*weightᵢ)−Σ(negative_actionᵢ*weightⱼ)

Recall that the display position assigned to a profile is determined by or correlates to the profile's current reputation. At 250, after the reputation value of the profile to which the item belongs has been adjusted, the display position for the profile is adjusted accordingly. Generally, if the reputation value of the profile has increased, the profile may be moved into a more prominent display position, and vice versa. At 270, the item is re-displayed at the adjusted display position associated with the profile to which the item belongs.

During the lifetime of an item, 240, 250, and 270 may be repeated multiple times. The frequency of the adjustment on the profile's reputation and corresponding display position(s) may depend on factors such as the lifespan of the item, the number of consumer actions or responses received, etc. For example, if an item receives many consumer actions or responses, then the adjustment may be made more frequently. Or, the adjustment may be made on a predetermined or regularly scheduled time period (e.g., once an hour, or once a day, etc.) basis.

In addition to the viewers or consumers, the website may be associated with or employ moderators who choose certain items that they believe would perform well and recommend these items to the viewers or consumers. At 260, during the lifetime of the item, its display position may also be adjusted based on an aggregated moderator selection or recommendation with respect to the item. The term “aggregated” as used here indicate that all recommendations from moderators who have chosen the item are taken into consideration when the display position for the item is adjusted.

The moderators may be considered as “experts” who, due to their individual experiences, expertise, and/or special knowledge, may know what items may perform well (e.g., popular among the consumers). Each moderator may pick one or more items currently available and being displayed on the website to recommend to the consumers. In addition, after a moderator has picked an item for recommendation, the moderator may also unpick the item to indicate that he or she no longer wishes to recommend the item. If an item is picked by one or more moderators, the item may be moved into a more prominent display position. If an item is unpicked by one or more moderators, the item may be moved into a less prominent display position.

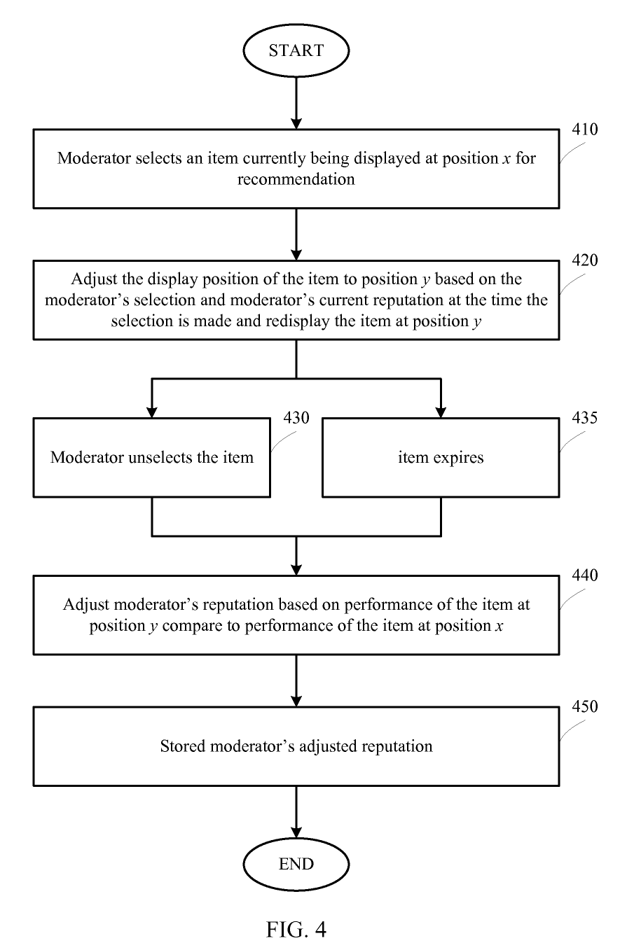

Similar to profiles and their associated reputation values, each moderator may be associated with a reputation as well, and the reputation values for all moderators may be stored. The reputation associated with a moderator may indicate how well that moderator has performed in choosing items or listings for recommendation in the past. For example, if a moderator generally picks and recommends items or listings that have performed well with the viewers or consumers, then a moderator may receive a relatively higher reputation value, and vice versa. Again, a moderator's reputation value may be adjusted from time to time based on the moderator's performance. The adjustment of a moderator's reputation is described in more detail below in FIG. 4.

How much a moderator's selection or recommendation affects the display position adjustment of the item or listing the moderator recommends may depend on that moderator's reputation level at the time the moderator chooses the item or listing. If a moderator has a relatively higher reputation level at the time when that moderator picks an item to recommend, it may move the item up more in terms of the prominence of the display position. On the other hand, if a moderator has a relatively lower reputation level at the time when that moderator picks an item to recommend, it may only move the item up slightly in terms of the prominence of the display position.

There are different ways to determine the actual formulas used to calculate the adjusted display position based on a moderator's recommendation and that moderator's reputation at the time the recommendation is made. For example, one formula for calculating the adjusted display position for an item when a moderator has picked that item for recommendation may be

adjusted display position expressed in terms of reputation=current display position expressed in terms of reputation+moderator's reputation

Similarly, one formula for calculating the adjusted display position for an item when a moderator has unpicked the previously recommended item to indicate that the moderator no longer wishes to recommend that item may be

adjusted display position expressed in terms of reputation=current display position expressed in terms of reputation−moderator's reputation

The above two formulas take into consideration the moderator's reputation value at the time when the moderator picks or unpicks the item. Furthermore, if multiple moderators all pick the same item to recommend, the item's display position may be adjusted upward even more so in terms of prominence, and the actual amount of adjustment may be based on the aggregated recommendation from all the moderators taking into consideration of each moderator's reputation value at the time that moderator makes the recommendation or selects the item (i.e., more weight given to recommendations from moderators with higher reputation).

To ensure that the moderators provide relatively independent and objective opinions instead of being influenced by other moderators, each moderator may be prevented from knowing the recommendations made by other moderators. In other words, each moderator picks items to recommend independently.

In addition, to prevent moderators from picking every available item or a majority of available items on the website to recommend, each moderator may be limited to be able to choose only a certain number of items at any given time to recommend. Once a moderator has chosen the maximum number of items allowed, in order to pick a new item to recommend, the moderator needs to first unpick one of the previously picked items. As described above, if an item is unpicked by a moderator, the item's display position is adjusted such that the item is moved downward in terms of the prominence of its display position. To summarize, when an item is picked by moderators for recommendation, the display position of the item may be adjusted such that the item is moved into a different, perhaps more prominent if warranted by the moderators' reputation levels, display position. When an item is unpicked by moderators, the display position of the item may be adjusted such that the item is moved into a different, perhaps less prominent if warranted by the moderators' reputation levels, display position.

After the item has been picked for recommendation or unpicked by one or more moderators and its display position has been adjusted as appropriate, at 270, the item is redisplayed at the adjusted display position. It is possible for a moderator to pick and unpick an item multiple times during the lifetime of the item, and with each moderator action, the display position of the item is adjusted accordingly.

From the method shown in FIG. 2, several factors affect the display position of an item. First, when a new item first becomes available, its initial display position is determined based on the current reputation value associated with the profile to which the item is matched (i.e., the profile that describes the new item). Then, during the lifetime of the item while it is being display on a web page, its display position may be adjusted from time to time based on: (1) viewer or consumer actions or responses with respect to the item, which also affect the reputation associated with the profile to which the item belongs, and (2) moderators' selection or un-selection of the item. Other factors may also affect the actual display position of the item at any given time. Thus, the actual display position of an item at any given time may be determined based on an aggregated value from all factors. In addition, different weight may be assigned to each factor when these factors are considered.

For the method shown in FIG. 2, the moderators may pick an item to recommend or unpick an item after the item has been displayed on a web page. In other words, the moderators' recommendations are not taken into consideration when determining the initial display position for the item when the item first becomes available. In an alternative embodiment, to determine a new item's initial display position, moderators' recommendations may also be taken into consideration in addition to the current reputation value of the profile to which the item is matched. In this case, moderators may apply their recommendations or make their selections before an item is ever displayed on a web page. However, there may be a delay in having the item displayed on a web page due to the time taken for moderators to review and choose the item for recommendation.

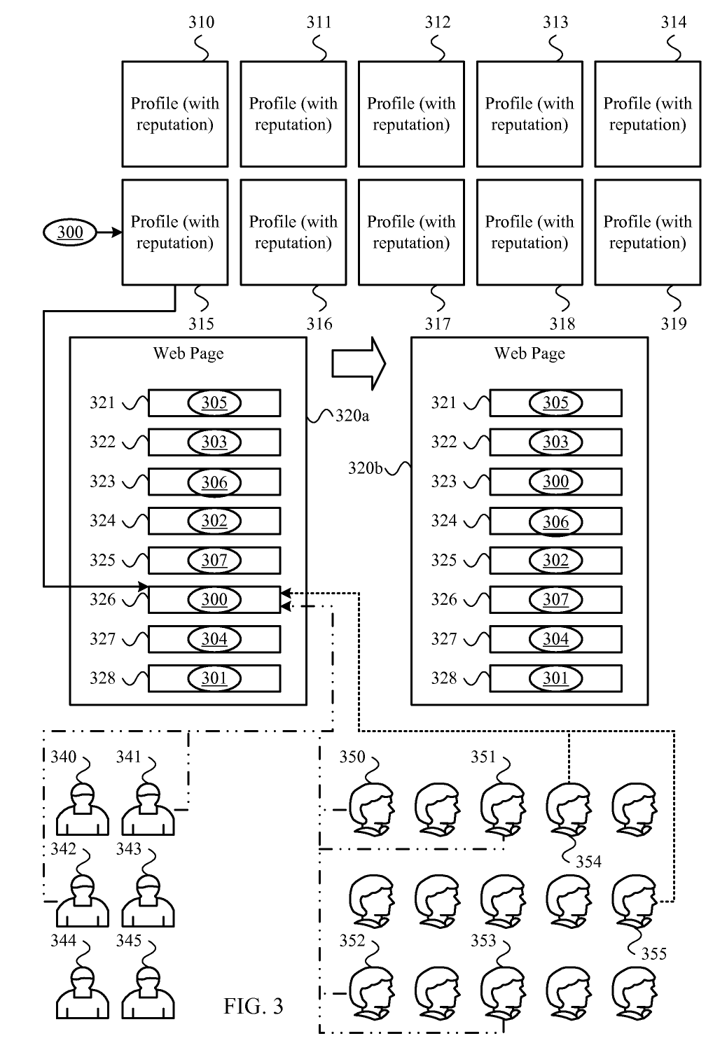

To further explain certain aspects of the method shown in FIG. 2 in more detail, FIG. 3 is a sample illustration of the steps resulting in an item to be moved into a more prominent display position. In the sample scenario illustrated in FIG. 3, the system associated with a website currently has ten profiles 310, 311, 312, 313, 314, 315, 316, 317, 318, 319, and each profile is associated with a reputation. Each profile 310, 311, 312, 313, 314, 315, 316, 317, 318, 319 represents or describes a different type of merchandise that the website is offering for sale. To simplify the description, each profile 310, 311, 312, 313, 314, 315, 316, 317, 318, 319 only has one item being offered for sale at any given time.

A new piece of merchandise, merchandise 300, has just become available. By matching the characteristics of merchandise 300, it may be determined that merchandise 300 matches profile 310. And based on the current reputation value of profile 310, items matching profile 310 should be displayed at position 326 on the web page. Thus, merchandise 300 is initially displayed at position 326 on the web page. Web page 320a shows that merchandise 300 is initially displayed at position 326 along with other pieces of merchandise 301, 302, 303, 304, 305, 306, 307 arranged in accordance with the reputation values of their respective profiles 311, 312, 313, 314, 315, 316, 317. The reputation level of profile 310 is less than that of profiles 315, 313, 316, 312, and 317 but greater than that of profiles 314 and 311. Further more, merchandise 305 belongs to profile 315 that has the highest reputation value, and is thus displayed at position 321 (i.e., the top position). Merchandise 303 belongs to profile 313 that has the second highest reputation value, and is thus displayed at position 322. Merchandise 306 belongs to profile 316 that has the third highest reputation value, and is thus displayed at position 323, and so on. Profiles 318 and 319 currently have no items being displayed.

Once merchandise 300 is displayed on the web page 320a, moderators and consumers may respond to or act on it. There are six moderators 340, 341, 342, 343, 344, 345 associated with the web site. Among the six moderators, moderators 341, 342 have decided to select merchandise 300 for recommendation. These two moderators' 341, 342 recommendations would be considered along with their respective reputation values when the display position of merchandise 300 is adjusted.

In addition, among the consumers who have visited the web site and viewed merchandise 300, four (consumers 350, 351, 352, and 353) have provided various types of positive actions or responses and two (consumers 354 and 355) have provided same or different types of negative actions or responses. These consumer actions or responses would be considered along with the weight given to each type of action or response when the reputation value of profile 310 is adjusted.

Considering all consumer actions or responses (i.e., aggregating all consumer actions or responses) with respect to merchandise 300, since there are four positive actions or responses (from consumers 350, 351, 352, and 353) and only two negative actions or responses (from consumer 354 and 355), the positive actions or responses probably outweigh the negative actions or responses. Therefore, the reputation value of profile 310 increases accordingly, which in turn results in items from profile 310 being displayed in a more prominent position on the web page.

At the same time, because two moderators 341, 342 have selected merchandise 300 for recommendation, it results in the display position of merchandise 300 being move up on the web page further (i.e., increase in prominence). Taking the moderators' recommendations and consumer actions all into account, merchandise 300 has been moved up to display position 323 on the web page. Web page 320b shows the same web page as web page 320a, but with merchandise 300 now being displayed at display position 323. Merchandise 306, 302, and 307 have been moved downward to accommodate the display position adjustment for merchandise 300. At this point, the reputation level of profile 310 is less than that of profiles 315 and 313, but greater than that of profiles 316, 312, 317, 314, and 311.

Another factor that may be taken into consideration when determining the display position of merchandise 300 is the expected performance associated with each of the display positions 323 and 326. Because position 323 is more prominent than position 326, the expected performance value for position 323 should generally be higher than the expected performance value for position 326. The actual performance of merchandise 300 may be compared against the expected performance values of the display positions where merchandise 300 is being displayed (i.e., first against expected performance value of position 326, and later against expected performance value of position 323). Whether merchandise 300 outperforms or under-performs the expected performance values associated with the display positions where merchandise 300 is being displayed may be used as an indication in determining whether merchandise 300 is being displayed at the appropriate display position best suited for merchandise 300 and/or profile 310.

As described above, each moderator in the system associated with the website is associated with a reputation value, which indicates how well that moderator has performed in recommending items. When a new moderator initially comes into the system, a default reputation value is assigned to the new moderator. For example, the default reputation value may be the medium value or another selected value among the range of possible reputation values associated with all the moderators. Thus, if the reputation values for all the moderators may range from 1 to 100, then the default reputation value would be 50 if the medium value is used as the default value, or could be 20 or some other number between 1 and 100 if some other criteria are used to determine the default value. Subsequently, the reputation value of a moderator is adjusted from time to time based on the moderator's performance.

FIG. 4 is a flowchart of a method that adjusts a moderator's reputation. At 410, a moderator selects an item currently being displayed at position x for recommendation. Because the moderator has recommended the item, at 420, the display position for the item is moved up to position y. How much the item is actually moved up in terms of prominence of display depends on the moderator's current reputation value at the time the moderator selects the item. With respect to each individual moderator, if the moderator currently has a relatively high reputation value, then the item may be moved up further due to that moderator's selection or recommendation than if the moderator currently has a relatively low reputation value. In other words, the difference between display position y (the new position) and display position x (the old position) depends on the moderator's reputation value at the time the recommendation is made.

The item is re-displayed at position y. At this point, the moderator has two options. First, at 430, the moderator may unpick or unselect the item at some point during the lifetime of the item. As described above, there are different ways to determine the actual formulas used to calculate the adjusted display position when a moderator has picked or unpicked an item. By unpicking an item, the moderator indicates that he or she no longer recommends the item. The moderator's unpicking or unselecting the item may cause the display position of the item to be adjusted and decreased in prominence.

There are various reasons a moderator may wish to unpick or unselect an item that he or she has previously chosen for recommendation. For example, the item may not be performing as well as the moderator had initially believed. Or, the moderator may wish to recommend another item but has reached the maximum number of items each moderator may pick at any given time. Or, the moderator may believe that the item has reached its peak, as perceived by the moderator, in terms of the reputation level of the profile to which the item is matched.

Alternatively, at 435, the moderator may let the item expire naturally. An item expires when it is no longer available or no longer being offered or displayed at the website. In this case, the moderator needs only to wait for the item to expire.

It is also possible for the moderator to specify a time period for which he or she recommends the item. At the end of the specified time period, the recommendation expires and thereafter, the moderator no longer recommends the item. The effect of this is similar to the moderator unselecting the item, except that in this case, the moderator is not required to unselect the item explicitly. Instead, the item is unselected (i.e., the recommendation expires) automatically at the end of the specified time period.

Once either 430 or 435 has occurred, at 440, the moderator's reputation value is adjusted based on the actual performance of the item. There are many ways to determine the actual formulas used to calculate the moderator's reputation value, and often the factors taken into consideration when determining such formulas depend on the requirements and/or preferences of the website system. For example, recall that each display position on a web page is associated with an expected performance value. Thus, if the item has outperformed the expected performance value for position y, it indicates that the moderator has made a good recommendation, and the moderator's reputation value should be increased accordingly. Conversely, if the item has underperformed the expected performance value for position y, it indicates that the moderator has made a bad recommendation, and the moderator's reputation value should be decreased accordingly.

In one embodiment, the gain or loss in reputation value of the moderator is a function of the change in the reputation of the profile with which the item is associated between the time the moderator selects the item and the time the moderator unselects the item or the item expires. While the item is being displayed at position y (the new position), it may receive consumer actions or responses, either positive or negative, which may cause the reputation associated with the profile to which the item belongs to change. Thus, at the time when either the moderator unselects the item (step 430) or the item expires (step 435), the reputation value of the profile to which the item belongs may differ from the reputation value of that same profile at the time when the item was originally selected by the moderator while being displayed at position x. If the reputation value of the profile at the time when the moderator unselects the item (step 430) while the item is being displayed at position y or when the item expires (step 435) is referred to as the “new profile reputation” and the reputation value of the profile at the time when the moderator selects the item while the item is being displayed at position x is referred to as the “old profile reputation,” then one formula that may be used to calculate a moderator's adjusted reputation may be

moderator's adjusted reputation=moderator's current reputation+(new profile reputation−old profile reputation)

Once the moderator's reputation value is adjusted, at 450, the new reputation value may be stored in the system to be used in the future.

The methods described above in FIGS. 2 and 4 may be implemented as computer programs and carried out in a programmed computing system. With specific implementations of the software programs, various types of data structures may be used to represent or describe concepts such as profiles, profile reputations, and moderator reputations. For example, an integer may be used to represent moderator reputation values, and the values may be normalized between 1 and 100. A programmer-defined structure may be used to represent a profile, and within the profile structure are fields that describe the criteria for the profile as well as the profile's reputation. SQL (structured query language) databases may be used to store information such as consumer responses, items, profiles, etc., and information stored in such databases may be modified, retrieved, and/or deleted using SQL-based programming codes.

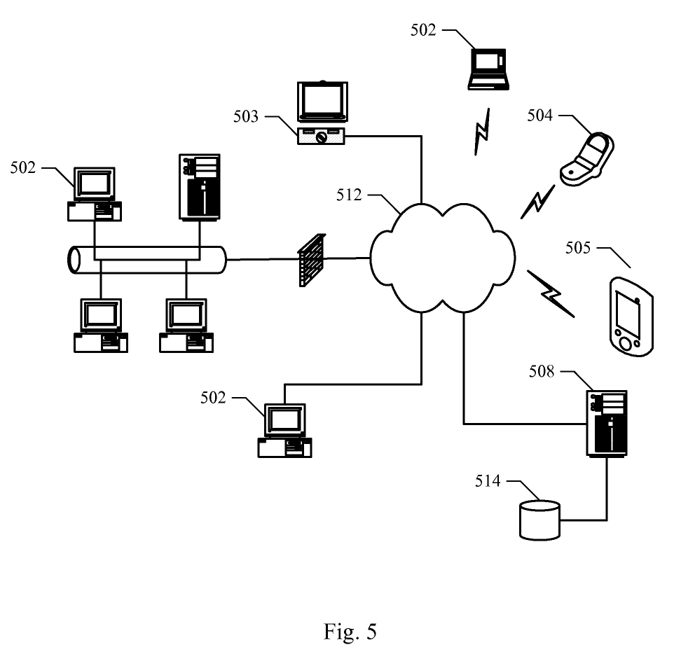

FIG. 5 is a simplified diagram of a network environment in which specific embodiments of the present invention may be implemented. The various aspects of the invention may be practiced in a wide variety of network environments (represented by network 512) including, for example, TCP/IP-based networks, telecommunications networks, wireless networks, etc. In addition, the computer program instructions with which embodiments of the invention are implemented may be stored in any type of computer-readable media, and may be executed according to a variety of computing models including, for example, on a stand-alone computing device, or according to a distributed computing model in which various of the functionalities described herein may be effected or employed at different locations. The software program implementing various embodiments may be executed on the server 508. Similarly, the website may be hosted on the server 508 or by one of the computers 502, 503.

According to various embodiments, viewers, consumers, and/or moderators may view the items displayed at the website through computers 502, 503, mobile phones 504, and PDAs (personal distal assistant) 505 via the network 512. Consumers may submit responses with respect to the items via the network 512. Moderators may also recommend or un-recommend items via the network 512. These responses and recommendations may be monitored by the software program implementing the system. Information about the items, profiles, and/or reputations for the profiles and moderators, as well as consumer responses may be stored databases 514 associated with the server 514 executing the system.

While this invention has been described in terms of several preferred embodiments, there are alterations, permutations, and various substitute equivalents, which fall within the scope of this invention. It should also be noted that there are many alternative ways of implementing the methods and apparatuses of the present invention. It is therefore intended that the following appended claims be interpreted as including all such alterations, permutations, and various substitute equivalents as fall within the true spirit and scope of the present invention.

What is claimed is:

1. A computer-implemented method for managing the display of items to which consumers may respond, comprising:
determining a first display position for an item based at least in part on a reputation associated with a profile to which the item belongs;
causing the item to be displayed at the first display position; and
during a lifetime of the item,
adjusting the reputation associated with the profile to which the item belongs based on an aggregated consumer response with respect to the item,
adjusting the display position of the item to a second display position based at least in part on the adjusted reputation associated with the profile, and
causing the item to be displayed at the second display position.

2. The computer-implemented method, as recited in claim 1, further comprising:
during the lifetime of the item, repeating at least once the steps of
adjusting the reputation associated with the profile to which the item belongs based on an aggregated consumer response with respect to the item,
adjusting the display position of the item to a second display position based at least in part on the adjusted reputation associated with the profile, and
causing the item to be displayed at the second display position.

3. The computer-implemented method, as recited in claim 1, wherein adjusting the reputation associated with the profile to which the item belongs based on an aggregated consumer response with respect to the item comprises:
for each positive consumer response with respect to the item, increasing the reputation of the profile; and
for each negative consumer response with respect to the item, decreasing the reputation of the profile.

4. The computer-implemented method, as recited in claim 3, wherein
a positive consumer response with respect to the item is one selected from the group consisting of a click on a web link associated with the item, a positive review given to the item, a positive rating given to the item, a thumbs-up to the item, a recommendation to another consumer with respect to the item, and a purchase of the item, and
a negative consumer response with respect to the item is one selected from the group consisting of a view of the item, a negative review given to the item, a negative rating given to the item, and a thumbs-down to the item.

5. The computer-implemented method, as recited in claim 4, further comprising:
associating different weights with different consumer responses,
wherein a consumer response associated with a relatively higher weight causes the reputation associated with the profile to be adjusted more than a consumer response associated with a relatively lower weight.

6. The computer-implemented method, as recited in claim 1, further comprising:
associating different display positions with different values of the reputation associated with the profile for displaying items belonging to the profile,
wherein a relatively higher reputation value corresponds to a relatively more prominent display position, and a relatively lower reputation value corresponds to a relatively less prominent display position.

7. The computer-implemented method, as recited in claim 1, further comprising:
during the lifetime of the item,
adjusting the display position of the item to a third display position based at least in part on an aggregated moderator response with respect to the item, and
causing the item to be displayed at the third display position.

8. The computer-implemented method, as recited in claim 7, further comprising:
during the lifetime of the item, repeating at least once the steps of
adjusting the display position of the item to a third display position based at least in part on an aggregated moderator response with respect to the item, and
causing the item to be displayed at the third display position.

9. The computer-implemented method, as recited in claim 7, wherein adjusting the display position of the item to a third display position based at least in part on an aggregated moderator response with respect to the item comprises:
for each moderator selection with respect to the item, adjusting the display position of the item to a relatively more prominent position based on a reputation associated with a moderator making the selection, and
for each moderator un-selection with respect to the item, adjusting the display position of the item to a relatively less prominent position based on a reputation associated with a moderator making the un-selection.

10. The computer-implemented method, as recited in claim 9, wherein a selection from a moderator associated with a relatively higher reputation causes the display position to be adjusted more than a selection from a moderator associated with a relatively lower reputation.

11. The computer-implemented method, as recited in claim 1, further comprising:
for each display position, determining an expected performance that represents an aggregated performance quality of items displayed at that display position.

12. The computer-implemented method, as recited in claim 1, further comprising:
creating the profile based on a plurality of criteria;
assigning a default value to the reputation associated with the newly created profile; and
storing the reputation associated with the profile.

13. The computer-implemented method, as recited in claim 12, further comprising:
determining the profile to which the item belongs, wherein the item belongs to the profile when the item matches the plurality of criteria associated with the profile.

14. A computer-implemented method for adjusting a reputation associated with a moderator who recommends items to consumers, comprising:
receiving a selection from the moderator with respect to an item displayed at a first display position;
adjusting the display position of the item to a second display position based at least in part on the reputation associated with the moderator;
causing the item to be displayed at the second display position;
monitoring performance of the item;
receiving an indication that the selection with respect to the item is completed; and
adjusting the reputation associated with the moderator based at least in part on the performance of the item.

15. The computer-implemented method, as recited in claim 14, wherein adjusting the reputation associated with the moderator based at least in part on the performance of the item comprises:
adjusting the reputation based at least in part on a difference between a second value and a first value of a reputation associated with a profile to which the item belongs,
wherein the first value is the value of the reputation associated with the profile to which the item belongs at a time when the selection from the moderator with respect to the item is received, and the second value is the value of the reputation associated with the profile to which the item belongs at a time when the selection is completed.

16. The computer-implemented method, as recited in claim 14, wherein an indication that the selection with respect to the item is completed is one selected from the group consisting of receiving a un-selection from the moderator with respect to the item, or the item is expired.

17. The computer-implemented method, as recited in claim 14, further comprising:
storing the reputation associated with the moderator.

18. The computer-implemented method, as recited in claim 14, further comprising:
limiting a number of items the moderator may recommend at any given time.

19. A computer program product for managing the display of items to which consumers may respond comprising a computer-readable medium having a plurality of computer program instructions stored therein, which are operable to cause at least one computing device to:
determine a first display position for an item based at least in part on a reputation associated with a profile to which the item belongs;
cause the item to be displayed at the first display position; and
during a lifetime of the item,
adjust the reputation associated with the profile to which the item belongs based on an aggregated consumer response with respect to the item,
adjust the display position of the item to a second display position based at least in part on the adjusted reputation associated with the profile, and
cause the item to be displayed at the second display position.

20. The computer program product, as recited in claim 19, wherein to adjust the reputation associated with the profile to which the item belongs based on an aggregated consumer response with respect to the item, the plurality of computer program instructions are operable to further cause the at least one computing device to:
for each positive consumer response with respect to the item, increase the reputation of the profile; and
for each negative consumer response with respect to the item, decrease the reputation of the profile.

21. The computer program product, as recited in claim 19, wherein the plurality of computer program instructions are operable to further cause the at least one computing device to:
associate different display positions with different values of the reputation associated with the profile for displaying items belonging to the profile,
wherein a relatively higher reputation value corresponds to a relatively more prominent display position, and a relatively lower reputation value corresponds to a relatively less prominent display position.

22. The computer program product, as recited in claim 19, wherein the plurality of computer program instructions are operable to further cause the at least one computing device to:
during the lifetime of the item,
adjust the display position of the item to a third display position based at least in part on an aggregated moderator response with respect to the item, and
cause the item to be displayed at the third display position.

23. The computer program product, as recited in claim 22, wherein to adjust the display position of the item to a third display position based at least in part on an aggregated moderator response with respect to the, the plurality of computer program instructions are operable to further cause the at least one computing device to:
for each moderator selection with respect to the item, adjust the display position of the item to a relatively more prominent position based on a reputation associated with a moderator making the selection, and
for each moderator un-selection with respect to the item, adjust the display position of the item to a relatively less prominent position based on a reputation associated with a moderator making the un-selection.

24. A computer program product for adjusting a reputation associated with a moderator who recommends items to consumers comprising a computer-readable medium having a plurality of computer program instructions stored therein, which are operable to cause at least one computing device to:
receive a selection from the moderator with respect to an item displayed at a first display position;
adjust the display position of the item to a second display position based at least in part on the reputation associated with the moderator;
cause the item to be displayed at the second display position;
monitor performance of the item;
receive an indication that the selection with respect to the item is completed; and
adjust the reputation associated with the moderator based at least in part on the performance of the item.

25. The computer program product, as recited in claim 24, wherein to adjust the reputation associated with the moderator based at least in part on the performance of the item, the plurality of computer program instructions are operable to further cause the at least one computing device to:
adjust the reputation based at least in part on a difference between a second value and a first value of a reputation associated with a profile to which the item belongs,
wherein the first value is the value of the reputation associated with the profile to which the item belongs at a time when the selection from the moderator with respect to the item is received, and the second value is the value of the reputation associated with the profile to which the item belongs at a time when the selection is completed.
